(19) United States
(12) Patent Application Publication
(10) Pub. No.: US 2007/0059400 A1
(43) Pub. Date: Mar. 15, 2007

(54) Composition containing ground lotus and/or lotus extract and lactic acid bacterium

(75) Inventors: Kiyoshi Goto, Saitama (JP); Haruhisa Wago, Saitama (JP)

Correspondence Address: WOLF, BLOCK, SHORR AND SOLIS-COHEN LLP, 250 PARK AVENUE, 10TH FLOOR, NEW YORK, NY, 10177, US

(73) Assignees: TOYO R & D INC, SAITAMA (JP); JAPAN ALLERGY APPLIED INSTITUTE CO. LTD, SAITAMA (JP)

(21) Appl. No.: 10/565,039

(22) PCT Filed: Jul. 18, 2003
(86) PCT No.: PCT/JP03/09207

§ 371 Date: Aug. 18, 2006

(51) Int. Cl. A23F 3/16

(52) U.S. Cl. 426/52

(57) ABSTRACT

The invention provides a composition, a drug, a food additive and a food, which comprises ground lotus and/or a lotus extract and a lactic acid bacterium. The composition, drug, food additive and food of the invention can be used to relieve and treat constipation, excessive sensitivity to cold, hemorrhoid, ear ringing, menopausal syndrome, hypertension and menstrual disorder.

### TECHNICAL FIELD

The present invention relates to a composition, a drug, a food additive and a food and in particular to a constipation-relieving drug, a constipation-relieving food additive and a constipation-relieving food, each of which containing ground lotus (Nelumbo nucifera) and/or a lotus extract and a lactic acid bacterium.

### BACKGROUND ART

An orally ingested food passes through the esophagus to reach the stomach and digested by the action of digestion enzymes contained in gastric juice and sent via the duodenum to the small intestine. In the small intestine, both nutrients necessary for the body and water are absorbed, and water not absorbed in the small intestine is subsequently absorbed in the large intestine, and excrement is thus formed and discharged from the anus via the rectum.

Such digestive organs from the mouth to anus are made very delicate, and the process of digesting, absorbing and discharging a food is influenced by the autonomous nervous system governing internal organs. Generally, the intestine which sends a food to the posterior part of intestine by contraction motion called peristaltic motion is a digestive organ estimated to be as long as about 9 meters in order to affect final evacuation smoothly, and it is very important that the actions of muscles involved in this peristaltic motion, secretion of digestive enzymes, absorption of nutrients and water and evacuation function well and continuously.

When the digestive tract functions well, the unpleasant condition of “constipation” making people impossible to defecate does generally not occur. In the modern society, however, peoples often feel stress and fatigue caused by overwork and unpleasant human relations, and often are short of sleep. Such stress and fatigue can adversely influence the autonomous nervous system governing functions of the digestive tract under the control of sympathetic nerves, and particularly weaken parasympathetic nerves in some cases. Due to the suppression of parasympathetic nerves function, functions of the digestive tract such as digestion, absorption and discharge do not act well, resulting in occurrence of constipation.

In constipation, there is not only a primary problem of failure to defecate but also a secondary problem caused by constipation. Namely, when the state of constipation continues, constipation itself becomes a cause of stress, and the autonomous nervous system will be out of balanced. As a result, the tension of sympathetic nerves may be increased to reduce immunity depending on lymphocytes and cause diseases attributable to an increase in active oxygen (stomach ulcer, ulcerative colitis, hemorrhoids, bad blood circulation, joint pain) etc. Constipation, when left unattended, can lead to colon diseases such as colon cancer and colon polyps as well as acute diseases such as ileus and intestinal volvulus.

Drugs for treating constipation include osmotic-pressure laxatives such as magnesium sulfate, magnesium oxide and Glauber's salt, but these drugs when administered in a large amount can bring about a poisonous condition in few cases, and when administered for a long time and in a large amount, can cause side-effects such as hypermagnemia. Anthraquinone-based colon-stimulative laxatives include constipation medicines based on senna, rhubarb, aloe or cascara sagrada, but these can cause side actions such as stomachache, nausea in few cases, vomiting, and borborygmus. Phenolphthalein-based colon-stimulative laxatives include phenovaline, bisacodyl, sodium picosulfate, etc., but these can cause side-actions such as nausea, vomiting, stomachache, borborygmus and abdominal inflation.

From conventionally eaten foods, those effective for constipation are searched for the purpose of relieving the disease safely without side-effects, and lactic acid bacteria (see Patent Literature 1) and dietary fibers contained in whole grain are known.

### DISCLOSURE OF INVENTION

However, there is a problem that the above-mentioned drugs used as pharmaceutical preparations can generate side-actions as described above. Dissolution of constipation by the drugs described above is mere symptomatic therapy, and the constipation of a person having constitutional constipation cannot be essentially solved.

There are materials derived from highly safe foods such as lactic acid bacteria and dietary fibers, but their effect cannot be demonstrated to be always satisfactory, so there has been demand for new materials.

The present inventors found that a composition containing ground lotus and/or a lotus extract; and lactic acid bacteria exhibits a significant effect on constipation, and on the basis of this finding, the present invention was completed.

The present invention provides a composition, a drug, a food additive and a food each containing ground lotus and/or a lotus extract; and lactic acid bacteria.

The present invention also provides a constipation-relieving drug, a constipation-relieving food additive and a constipation-relieving food each containing ground lotus and/or a lotus extract; and lactic acid bacteria.

In the present invention, the “lotus” refers to Nelumbo nucifera belonging to the subfamily Nelumboideae in the family Nymphaeaceae. A subterranean stem of the lotus is generally called “lotus root” and commercially available.

As the lotus to be formed into the ground lotus or extract in the present invention, any part of the lotus plant can be used, and examples thereof include, but are not limited to, a subterranean stem (lotus root), stem, leaf, root, seed, and a combination thereof. The lotus used in a ground state or as an extract is preferably a subterranean stem, stem, leaf or root of the lotus, or a combination thereof, more preferably a subterranean stem, stem or leaf of the lotus, or a combination thereof, still more preferably a subterranean stem of the lotus.

The ground lotus can be prepared by grinding a lotus by any method using any apparatus such as a mixer or a mill. This grinding may be carried out in a mode where a lotus in the presence of a solvent such as water, or a lotus only, is ground. The ground lotus in the present invention may be a ground product itself which is prepared by grinding a lotus. The ground lotus in the present invention may be subjected to heating and/or dehydration before, during or after grinding. Heating and/or dehydration may or may not be conducted.

Preferable examples of the ground lotus include, but are not limited to, a product which is obtained by grinding a lotus, and then heating and drying the grounded lotus, a product which is obtained by drying a lotus and then grinding the dried lotus, a product which is obtained by heating a lotus and then grinding the heated lotus, and a product which is obtained by heating and drying a lotus (the order of heating and drying is not limited) and then grinding the dried (or heated) lotus. In a certain embodiment, an intact lotus may be subjected directly to drying treatment such as freeze-drying or drying with infrared light and then to grinding.

The ground lotus may be a concentrate of the lotus from which water is partially removed, and in this case, the concentrating treatment in preparation of the ground lotus includes, but is not limited to, a mode in accordance with the drying treatment described above.

The ground product can be in any form such as paste, solid, granules, powder, liquid (including the product in any state such as solution and suspension), and the ground product in such form can be produced in any method known in the art. For example, the ground product can be prepared so as to be in such form directly from a lotus, or as described above, the ground product obtained once in a dry state by drying treatment can be prepared so as to be in such form.

When the drying or concentrating treatment is carried out in preparation of the ground lotus, the method of drying or concentrating treatment may be any method known in the art, which includes, but is not limited to, a freeze-drying method (method of drying under reduced pressure), a concentrating method under reduced pressure, a method of drying with microwaves under reduced pressure, a method of drying with microwaves at normal pressures and a heating drying method such as drying with far infrared light or drying with near infrared light. Preferably, the method of drying or concentrating treatment is a freeze-drying method, a concentrating method under reduced pressure or a method of drying with far infrared light.

When the drying or concentrating treatment is carried out in preparation of the ground lotus, the treatment temperature varies depending on the method used, but is preferably −50° C. to 100° C., more preferably −30° C. to 70° C., still more preferably −30° C. to 60° C.

Besides heating conducted sometimes in the drying or concentrating treatment in preparation of the ground lotus, heating treatment for unlimited purposes such as sterilization may be conducted. In this case, the heating temperature is preferably 100° C. or less. That is, it is preferable that a temperature of higher than 100° C. is not applied in the process of forming the lotus into the ground lotus.

One preferable embodiment of the ground lotus used in the present invention can be a freeze-dried or far infrared light-dried ground lotus which is prepared by a method including either a step 1) wherein a lotus is ground, and the resulting ground lotus is freeze-dried or dried with far infrared light or a step 2) wherein a lotus is freeze-dried or dried with far infrared light, and then the dried lotus is ground.

In the present invention, the lotus extract is not limited to an extract obtained by extraction treatment with a solvent to transfer components in the lotus into the solvent. Extracts prepared by extracting any component from a lotus directly without a solvent or the like (e.g., a fluid obtained by pressing a lotus) also fall under the scope of the extract referred to in the present invention. The extract may be prepared at room temperature, or may be prepared under heating. Examples of the lotus extract include, for example, juices obtained by pressing thinly cut or ground lotuses, juices obtained by pressing thinly cut or ground lotuses under heating, and extracts obtained by extracting thinly cut or ground lotuses with a solvent with or without heating. The solvent usable in solvent extraction can be a solvent such as water, ethanol, propylene glycol, n-butanol, ethyl acetate, chloroform; or a mixed solvent of two or more thereof. The solvent used in extraction is preferably water. The extract can be concentrated or evaporated to dryness if necessary. The extract can be in any form such as paste, solid, granules, powder, liquid (including an extract in any state such as solution and suspension), and the extract in such form can be produced in any known method.

When the drying or concentrating treatment is carried out in preparation of the lotus extract, the method of drying or concentrating treatment may be any method known in the art, which includes, but is not limited to, a freeze-drying method (method of drying under reduced pressure), a concentrating method under reduced pressure, a method of drying with microwaves under reduced pressure, a method of drying with microwaves at normal pressures and a heating drying method such as drying with far infrared light or drying with near infrared light. Preferably, the method of drying or concentrating treatment is a freeze-drying method, a concentrating method under reduced pressure or a method of drying with far infrared light.

When the drying or concentrating treatment is carried out in preparation of the lotus extract, the treatment temperature varies depending on the method used, but is preferably −50° C. to 100° C., more preferably −30° C. to 70° C., still more preferably −30° C. to 60° C.

Besides heating which may be conducted in the drying or concentrating treatment in preparation of the lotus extract, heating treatment for unlimited purposes such as sterilization may be conducted. In this case, the heating temperature is preferably 100° C. or less. That is, it is preferable that a temperature of higher than 100° C. is not applied in the process of making the lotus extract from the lotus.

One preferable embodiment of the lotus extract used in the present invention may be a freeze-dried or far infrared light-dried lotus extract which is prepared by a method including a step wherein a lotus root is subjected to extraction, and the resulting lotus extract is freeze-dried or dried with far infrared light. Another embodiment may be a lotus extract concentrated under a condition of reduced pressure, prepared by a method including a step of concentrating the lotus extract under reduced pressure.

In the present invention, either the ground lotus or the lotus extract, or both the ground lotus and the lotus extract may be contained in a composition, a drug, a food additive and a food.

The lactic acid bacteria used in the present invention include, but are not limited to, lactic acid bacteria belonging to the genera Lactobacillus, Streptococcus, Bifidobacterium and Bacillus. From the viewpoint of allowing orally ingested lactic acid bacteria to be alive and easily reach the intestine, the lactic acid bacteria are preferably sporing lactic acid bacteria. The sporing lactic acid bacteria include, but are not limited to, for example, Bacillus coagulansetc.

In the present specification, the “constipation” refers to a state in which the frequency of defecation in a person is significantly lower than that in the usual habit of defecation in that person, and specific symptoms include, but are not limited to, less excrement, hard excrement, difficult defecation, low frequency of defecation, and feel of incomplete defecation.

In the present specification, the “constipation-relieving drug” is a drug for relieving and treating constipation, the “constipation-relieving food additive” is a food additive for relieving and treating constipation, and the “constipation-relieving food” is a food for relieving and treating constipation.

The composition of the present invention can contain any known ingredients unless they are against the object of the present invention.

In the present invention, the drug can be orally administered. For manufacturing a pharmaceutical preparation of the drug of the present invention, the drug can be formed into a pharmaceutical preparation by any usual method in the technical field of pharmaceutical manufacturing, and for example, pharmaceutical forms such as tablets, granules, powder, capsules, syrups and troches can be used. The drug in the present invention can contain drug constituent ingredients acceptable for constituting the drug, in addition to the ground lotus and/or the lotus extract and lactic acid bacteria. The acceptable drug constituent ingredients are recognized by those skilled in the art, and not particularly limited. For example, when a solid pharmaceutical preparation for oral administration is prepared, a vehicle and if necessary a binder, a lubricant, a coloring agent, a taste corrective and a flavor corrective can be used together with the ground lotus and/or the lotus extract; and lactic acid bacteria, and these ingredients are added to the drug and then formed in a usual manner into tablets, granules, powder, capsules, troches, sugar-coated tablets, etc.

The amounts of the ground lotus and/or the lotus extract and lactic acid bacteria contained in the composition or drug of the present invention, and the proportion of these active ingredients contained therein, are not particularly limited insofar as the composition or drug of the present invention can demonstrate its effect.

With respect to the dose of the composition or drug of the invention administered orally into human, the amount of the ground lotus on a dry-weight basis is preferably 1 to 100 g, more preferably 2 to 40 g, per day for adult, and the amount of the lotus extract on a dry-weight basis is preferably 0.5 to 50 g, more preferably 1 to 20 g. The daily dose of lactic acid bacteria orally administered into adult is preferably 500,000 to 5 billions (number of bacteria), more preferably 5 millions to 1 billion (number of bacteria), in terms of the number of bacteria.

The food additive in the present invention may be an additive which can be added to a food, and the object of the food additive is not limited. For production of the food additive of the present invention, the food additive can be produced in the form of solid, granules, powder, capsules, solution, suspension etc. by a usual method in the technical field of food additive. The food additive of the present invention can contain another ingredient acceptable as food additive, and the other ingredient is recognized by those skilled in the art, and is not particularly limited.

The amount of the ground lotus and/or the lotus extract contained in the food additive of the present invention, the amount of lactic acid bacteria contained therein, and the proportion of these ingredients contained therein are not particularly limited, and vary in a depending manner on the type of food and the amount of the food additive added to food.

The food in the present invention is not particularly limited insofar as it contains the ground lotus and/or the lotus extract and lactic acid bacteria. The type of food is not particularly limited insofar as it is to be ingested usually as food, and the food includes, but is not limited to, foods called health food or supplement in forms such as tablets, granules, powder and capsules, noodles including udon (thick white noodles), buckwheat noodles, pasta and ramen, flour such as wheat flour, buckwheat flour, potato starch, and rice flour, bread such as sweet roll and sliced bread, confectionery such as cake, cookie, rice cracker, bean jam, yokan (sweetened and jellied bean paste), rice cake, dumpling and jelly, drinks such as juice and tea, and instant foods such as instant Chinese noodles, instant miso soup, and instant soup. The foods of the present invention are preferably foods such as bread, cake, cookie and rice cracker produced from flour such as wheat flour, buckwheat flour, potato starch, and rice flour containing the ground lotus and/or the lotus extract and lactic acid bacteria. The foods of the present invention are more preferably foods such as bread, cake, cookie and rice cracker produced from flour such as wheat flour, buckwheat flour, potato starch, and rice flour containing the ground lotus and/or the lotus extract in a powdery form and lactic acid bacteria. In another preferable embodiment, the food of the present invention is yogurt containing the ground lotus and/or the lotus extract and lactic acid bacteria. As used herein, yogurt includes not only usual semi-solid yogurt but also liquid yogurt such as yogurt drink. In production of the food of the present invention, any known methods and materials can be used.

The amounts of the ground lotus and/or the lotus extract and lactic acid bacteria contained in the food of the present invention, and the proportion of these ingredients contained therein, are not particularly limited insofar as the food of the present invention can demonstrate its effect.

The food of the present invention is in such a food form as to allow the ground lotus in an amount of preferably 1 to 100 g, more preferably 2 to 40 g, on a dry-weight basis, to be ingested per day by adult, or in such a food form to allow the lotus extract in an amount of preferably 0.5 to 50 g, more preferably 1 to 20 g, on a dry-weight basis, to be ingested per day by adult. The food of the present invention is also in such a food form that in oral administration, lactic acid bacteria in an amount of preferably 500,000 to 5 billions (number of bacteria), more preferably 5 millions to 1 billion (number of bacteria), in terms of the number of bacteria, are ingested per day by adult.

The food of the present invention can be produced by adding the ground lotus and/or the lotus extract, and lactic acid bacteria, to a starting material constituting the food, or by adding the food additive of the present invention to a starting material constituting the food. Depending on the type of food, the food additive of the present invention can be added to a produced food thereby constituting the food of the present invention.

Because of incorporation of the ground lotus and/or the lotus extract and lactic acid bacteria, the composition, drug, food additive and food of the present invention, as compared with those containing only one of such ingredients, have an advantageous synergistic effect superior to mere additive effect in respect of achievement of relief and treatment of constipation. The composition, drug, food additive and food of the present invention also have an advantageous effect of achieving relief and treatment of excessive sensitivity to cold, hemorrhoid, ear ringing, menopausal syndrome, hypertension and menstrual disorder.

### BRIEF DESCRIPTION OF THE DRAWING

FIG. 1 indicates a change with time of the mean frequency of defecation in Examples 1 and 2 and Comparative Examples 1 to 4.

### BEST EMBODIMENT FOR CARRYING OUT THE INVENTION

Hereinafter, the present invention is described in more detail by reference to the Examples, but the present invention is not limited to the scope of the Examples.

### EXAMPLES

### Example 1

Drug Containing a Lotus Root Extract and Lactic Acid Bacteria

1) Method of Preparing a Lotus Root Extract

One hundred kg commercial lotus root was peeled, then washed with water and cut into slices of 5 to 10 mm in thickness. Two hundreds sixty (260) L water was added thereto, and the water and lotus root were introduced into a kneader and heated to 98° C. under stirring. After heating to 99° C., the sample was boiled for 30 minutes. Then, the boiled product was removed from the kneader and then filtered through bleached cotton to give a filtrate which was then powdered by freeze-drying method. By this operation, five kg lotus extract powder was obtained.

2) Method of Preparing a Constipation-Relieving Drug

The lotus extract (powder):sporing lactic acid bacteria for food (containing at least 5 billions (number of bacteria) of Bacillus coagulans per g, and containing lactose as a vehicle):maltose starch syrup were mixed at a ratio of 70:1:29, and the mixture was formed into spherical tablets (about 320 mg/tablet) of 8 mm in diameter, and this tablet was used as constipation-relieving drug.

3) Applied Dose of the Constipation-Relieving Drug and Administration Schedule

A profile of subjects having constipation symptoms is as follows:

The subjects were 20 subjects, among whom when a constipation drug available commercially or from hospital was not ingested, ten subjects (Subject Nos. A1 to A10) had defecation once every 2 to 3 days and 10 subjects (Subject Nos. AA1 to AA10) had defecation once every 4 to 7 days.

The subjects ingested the constipation-relieving drug by taking 10 tablets once per day for 4 weeks together with water or hot water. During the test period, no other constipation drug was ingested.

The relief of constipation was judged in terms of the frequency of defecation per week and by a subject's report on other subjective symptoms.

### Comparative Example 1

Drug Containing Only the Lotus Root Extract

Tablets were prepared in the same manner as in Example 1 except that the composition of the constipation-relieving drug contained the lotus root extract prepared in Example 1 but did not contain lactic acid bacteria.

Namely, in Comparative Example 1, the lotus root extract prepared in Example 1:maltose starch syrup were mixed at a ratio of 70:30, and the mixture was formed into spherical tablets (about 320 mg/tablet) of 8 mm in diameter, and this tablet was used as constipation-relieving drug.

Subjects were 20 subjects, among whom when a constipation drug available commercially or from hospital was not ingested, 10 subjects (Subject Nos. B1 to B10) had defecation once every 2 to 3 days and 10 subjects (Subject Nos. BB1 to BB10) had defecation once every 4 to 7 days.

The test method, period and evaluation method were the same as in Example 1.

### Comparative Example 2

Ingestion of a Doubled Amount of the Drug Containing Only the Lotus Root Extract

The constipation-relieving drug containing the lotus root extract but not containing lactic acid bacteria, prepared in Comparative Example 1, was used, and the amount of the constipation-relieving drug ingested by a subject was twice (20 tablets given once per day) that in Comparative Example 1.

Subjects were 20 subjects, among whom when a constipation drug available commercially or from hospital was not ingested, 10 subjects (Subject Nos. b1 to b10) had defecation once every 2 to 3 days and 10 subjects (Subject Nos. bb1 to bb10) had defecation once every 4 to 7 days.

The test method, period and evaluation method were the same as in Example 1.

### Comparative Example 3

Drug Containing only the Lactic Acid Bacteria

Tablets were prepared in the same manner as in Example 1 except that the composition of the constipation-relieving drug contained the lactic acid bacteria but did not contain the lotus root extract.

Namely, in Comparative Example 3, sporing lactic acid bacteria powder for food:maltose starch syrup were mixed at a ratio of 1:99, and the mixture was formed into spherical tablets (about 320 mg/tablet) of 8 mm in diameter, and this tablet was used as constipation-relieving drug.

Subjects were 20 subjects, among whom when a constipation drug available commercially or from hospital was not ingested, 10 subjects (Subject Nos. C1 to C10) had defecation once every 2 to 3 days and 10 subjects (Subject Nos. CC1 to CC10) had defecation once every 4 to 7 days.

The test method, period and evaluation method were the same as in Example 1.

### Comparative Example 4

Ingestion of a Doubled Amount of the Drug Containing Only the Lactic Acid Bacteria

The constipation-relieving drug containing the lactic acid bacteria but not containing the lotus root extract, prepared in Comparative Example 3, was used, and the amount of the constipation-relieving drug ingested by a subject was as twice (20 tablets given once per day) that in Comparative Example 3.

Subjects were 20 subjects, among whom when a constipation drug available commercially or from hospital was not ingested, 10 subjects (Subject Nos. c1 to c10) had defecation once every 2 to 3 days and 10 subjects (Subject Nos. cc1 to cc10) had defecation once every 4 to 7 days.

The test method, period and evaluation method were the same as in Example 1.

### Example 2

Drug Containing Ground Lotus Root and Lactic Acid Bacteria

1) Method of Preparing Ground Lotus Root

Commercial lotus root was peeled, then washed with water and cut into slices of 5 to 10 mm in thickness. The slices were heated at 110° C. for 15 minutes with a retort machine. After heating, the lotus root was cut thin, and the thinly cut lotus root was dried with hot water at 50 to 60° C. for 15 hours. Then, the sample was pulverized with an atomizer using a 1-mm screen to give ground lotus (powder).

2) Method of Preparing a Constipation-Relieving drug

The ground lotus root (powder):sporing lactic acid bacteria powder for food:maltose starch syrup were mixed at a ratio of 70:1:29, and the mixture was formed into spherical tablets (about 320 mg/tablet) of 8 mm in diameter, and this tablet was used as constipation-relieving drug.

3) Applied Dose of the Constipation-Relieving Drug and Administration Schedule

A profile of subjects having constipation symptoms is as follows:

The subjects were 20 subjects, among whom when a constipation drug available commercially or from hospital was not ingested, 10 subjects (Subject Nos. D1 to D10) had defecation once every 2 to 3 days and 10 subjects (Subject Nos. DD1 to DD10) had defecation once every 4 to 7 days.

The test method, period and evaluation method were the same as in Example 1.

The frequency of defecation in each subject before administration of the constipation-relieving drug and during administration for 4 weeks, and the mean frequency of defecation in each group, in the tests in Example 1, Comparative Examples 1 to 4 and Example 2 are shown in Tables 1 to 6. The results in Example 1 are shown in Table 1; the results in Comparative Example 1 in Table 2; the results in Comparative Example 2 in Table 3; the results in Comparative Example 3 in Table 4; the results in Comparative Example 4 in Table 5; and the results in Example 2 in Table 6. The frequency of defecation is expressed as the number of times a bowel movement occurred per week. A decimal point appears in the tables because when there was a bowel movement but the amount of excrement was lower than usual, the bowel movement was reported in terms of a ratio to the usual amount (assumed to be “1”) of excrement. For example, when there was a bowel movement but the amount of excrement was about half of the usual amount of excrement, the bowel movement was expressed as “0.5”.

The constipation-relieving effect on the fourth week (shown in “Constipation-relieving effect on fourth week” in the tables) was shown in the following manner: When the frequency of defecation on the fourth week was at least twice per week that before the ingestion of the constipation-relieving drug, the defecation was considered “significantly relieved” and expressed as “∘” in the tables; when the frequency of defecation per week was increased, but the frequency of defecation was not increased to be twice or more, the defecation was considered “embodimentrately relieved” and expressed as “▴” in the tables; and when the frequency of defecation per week was not changed, the defecation was considered “not changed” and expressed as “-” in the tables.

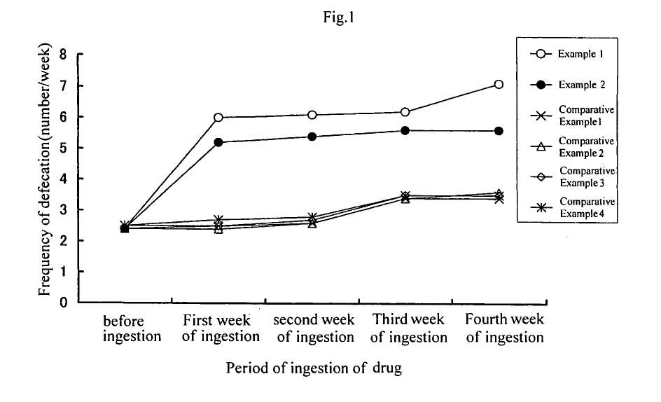

A graph showing a change in the mean frequency of defecation in Examples 1 and 2 and Comparative Examples 1 to 4 is shown in FIG. 1.

TABLE 1
Example 1 (Ingredients: lotus root extract + lactic acid bacterium)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| A1 | 3.0 | 7.0 | 7.0 | 7.0 | 7.0 | ◯ |
| A2 | 3.5 | 7.0 | 7.0 | 7.0 | 7.0 | ◯ |
| A3 | 3.0 | 5.0 | 5.0 | 5.0 | 6.0 | ▴ |
| A4 | 3.5 | 7.0 | 7.0 | 7.0 | 7.0 | ◯ |
| A5 | 3.5 | 8.0 | 8.0 | 9.0 | 9.0 | ◯ |
| A6 | 3.5 | 9.0 | 9.0 | 9.0 | 9.0 | ◯ |
| A7 | 3.0 | 7.0 | 7.0 | 7.0 | 7.0 | ◯ |
| A8 | 3.0 | 7.0 | 7.0 | 7.0 | 7.0 | ◯ |
| A9 | 3.5 | 7.0 | 8.0 | 8.0 | 8.0 | ◯ |
| A10 | 3.0 | 7.0 | 7.0 | 7.0 | 7.0 | ◯ |
| Mean in | 3.3 | 7.1 | 7.2 | 7.3 | 7.7 | |
| group A | | | | | | |
| AA1 | 1.0 | 5.0 | 5.0 | 5.0 | 7.0 | ◯ |
| AA2 | 1.0 | 6.0 | 6.0 | 7.0 | 7.0 | ◯ |
| AA3 | 1.0 | 6.0 | 7.0 | 7.0 | 8.0 | ◯ |
| AA4 | 2.0 | 4.0 | 4.0 | 4.0 | 6.0 | ◯ |
| AA5 | 1.0 | 6.0 | 7.0 | 7.0 | 7.0 | ◯ |
| AA6 | 2.0 | 4.0 | 4.0 | 4.0 | 7.0 | ◯ |
| AA7 | 2.0 | 6.0 | 6.0 | 6.0 | 7.0 | ◯ |
| AA8 | 2.0 | 5.0 | 5.0 | 5.0 | 8.0 | ◯ |
| AA9 | 1.0 | 1.0 | 1.0 | 1.0 | 1.0 | — |
| AA10 | 2.0 | 5.0 | 5.0 | 5.0 | 7.0 | ◯ |
| Mean in | 1.5 | 4.8 | 5.0 | 5.1 | 6.5 | |
| group AA | | | | | | |
| Mean in | 2.4 | 6.0 | 6.1 | 6.2 | 7.1 | |
| the total | | | | | | |

TABLE 2
Comparative Example 1 (Ingredient: lotus root extract)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| B1 | 3.5 | 3.5 | 3.5 | 3.5 | 3.5 | — |
| B2 | 3.5 | 3.5 | 4.0 | 7.0 | 7.0 | ◯ |
| B3 | 3.0 | 3.0 | 3.0 | 7.0 | 7.0 | ◯ |
| B4 | 3.0 | 3.0 | 3.0 | 3.0 | 3.0 | — |
| B5 | 3.5 | 3.5 | 3.5 | 3.5 | 3.5 | — |
| B6 | 3.5 | 3.5 | 4.0 | 5.0 | 5.0 | ▴ |
| B7 | 3.5 | 4.0 | 4.0 | 5.0 | 5.0 | ◯ |
| B8 | 3.5 | 3.5 | 4.0 | 7.0 | 8.0 | ◯ |
| B9 | 3.5 | 3.5 | 3.5 | 3.5 | 3.5 | — |
| B10 | 3.0 | 3.0 | 3.0 | 3.0 | 3.0 | — |
| Mean in | 3.4 | 3.4 | 3.6 | 4.8 | 4.9 | |
| group B | | | | | | |
| BB1 | 1.0 | 1.0 | 1.0 | 1.0 | 1.0 | — |
| BB2 | 1.0 | 1.0 | 1.0 | 1.0 | 1.0 | — |
| BB3 | 2.0 | 2.0 | 2.0 | 3.0 | 3.0 | ▴ |
| BB4 | 2.0 | 2.0 | 2.0 | 2.0 | 2.0 | — |
| BB5 | 1.0 | 1.0 | 1.0 | 1.0 | 1.0 | — |
| BB6 | 2.0 | 2.0 | 2.0 | 2.0 | 2.0 | — |
| BB7 | 1.0 | 1.0 | 2.0 | 3.0 | 3.0 | ◯ |
| BB8 | 2.0 | 2.0 | 2.0 | 3.0 | 3.0 | ▴ |
| BB9 | 2.0 | 2.0 | 2.0 | 2.0 | 2.0 | — |
| BB10 | 1.0 | 1.0 | 1.0 | 1.0 | 1.0 | — |
| Mean in | 1.5 | 1.5 | 1.6 | 1.9 | 1.9 | |
| group BB | | | | | | |
| Mean in | 2.5 | 2.5 | 2.6 | 3.4 | 3.4 | |
| the total | | | | | | |

TABLE 3
Comparative Example 2 (Ingredient: doubled
amount of lotus root extract)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| b1 | 3.5 | 3.5 | 3.5 | 3.5 | 3.5 | — |
| b2 | 3.0 | 3.5 | 4.0 | 7.0 | 7.0 | ◯ |
| b3 | 3.5 | 3.5 | 4.0 | 7.0 | 7.0 | ◯ |
| b4 | 3.0 | 3.0 | 3.0 | 3.0 | 3.0 | — |
| b5 | 3.5 | 3.5 | 3.5 | 3.5 | 3.5 | — |
| b6 | 3.0 | 3.0 | 3.0 | 5.0 | 5.0 | ▴ |
| b7 | 3.0 | 3.0 | 3.0 | 3.0 | 3.0 | — |
| b8 | 3.0 | 4.0 | 5.0 | 7.0 | 8.0 | ◯ |
| b9 | 3.5 | 4.0 | 4.0 | 4.0 | 5.0 | ▴ |
| b10 | 3.5 | 3.0 | 3.0 | 3.0 | 3.0 | — |
| Mean in | 3.3 | 3.4 | 3.6 | 4.6 | 4.8 | |
| group b | | | | | | |
| bb1 | 1.0 | 1.0 | 1.0 | 1.0 | 1.0 | — |
| bb2 | 1.0 | 1.0 | 1.0 | 1.0 | 1.0 | — |
| bb3 | 1.0 | 1.0 | 1.0 | 3.0 | 3.0 | ◯ |
| bb4 | 2.0 | 1.0 | 1.0 | 3.5 | 3.5 | ▴ |
| bb5 | 2.0 | 2.0 | 2.0 | 2.0 | 3.0 | — |
| bb6 | 2.0 | 3.0 | 3.0 | 4.0 | 4.0 | ◯ |
| bb7 | 1.0 | 1.2 | 1.8 | 1.8 | 1.8 | ▴ |
| bb8 | 1.0 | 1.0 | 2.0 | 3.0 | 3.0 | ◯ |
| bb9 | 2.0 | 2.0 | 2.0 | 2.0 | 2.0 | — |
| bb10 | 1.0 | 1.0 | 1.0 | 1.0 | 1.0 | — |
| Mean in | 1.4 | 1.4 | 1.6 | 2.2 | 2.3 | |
| group bb | | | | | | |
| Mean in | 2.4 | 2.4 | 2.6 | 3.4 | 3.6 | |
| the total | | | | | | |

TABLE 4
Comparative Example 3 (Ingredient: lactic acid bacterium)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| C1 | 3.5 | 3.5 | 3.5 | 3.5 | 3.5 | — |
| C2 | 3.0 | 3.0 | 4.0 | 7.0 | 7.0 | ◯ |
| C3 | 3.0 | 3.0 | 3.0 | 3.0 | 3.0 | — |
| C4 | 3.0 | 3.0 | 3.0 | 3.0 | 3.0 | — |
| C5 | 3.5 | 4.0 | 4.0 | 5.0 | 5.0 | ▴ |
| C6 | 3.5 | 4.0 | 5.0 | 5.0 | 5.0 | ▴ |
| C7 | 3.5 | 3.5 | 3.5 | 3.5 | 3.5 | — |
| C8 | 3.0 | 4.0 | 4.0 | 7.0 | 7.0 | ◯ |
| C9 | 3.0 | 3.0 | 3.0 | 3.0 | 3.0 | — |
| C10 | 3.0 | 3.0 | 3.0 | 6.0 | 8.0 | ◯ |
| Mean in | 3.2 | 3.4 | 3.6 | 4.6 | 4.8 | |
| group C | | | | | | |
| CC1 | 1.0 | 1.0 | 1.0 | 1.0 | 1.0 | — |
| CC2 | 1.0 | 1.0 | 1.0 | 1.0 | 1.0 | — |
| CC3 | 2.0 | 2.0 | 2.0 | 3.5 | 3.5 | ▴ |
| CC4 | 1.0 | 1.0 | 1.0 | 1.0 | 1.0 | — |
| CC5 | 1.0 | 1.0 | 1.0 | 1.0 | 1.0 | — |
| CC6 | 2.0 | 2.0 | 2.0 | 2.0 | 2.0 | — |
| CC7 | 2.0 | 2.0 | 3.0 | 3.0 | 3.0 | ▴ |
| CC8 | 2.0 | 3.0 | 3.0 | 7.0 | 7.0 | ◯ |
| CC9 | 2.0 | 2.0 | 2.0 | 2.0 | 2.0 | — |
| CC10 | 1.0 | 1.0 | 1.0 | 1.0 | 1.0 | — |
| Mean in | 1.5 | 1.6 | 1.7 | 2.3 | 2.3 | |
| group CC | | | | | | |
| Mean in | 2.4 | 2.5 | 2.7 | 3.5 | 3.5 | |
| the total | | | | | | |

TABLE 5
Comparative Example 4 (Ingredient: doubled
amount of lactic acid bacterium)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| c1 | 3.5 | 3.5 | 3.5 | 3.5 | 3.5 | — |
| c2 | 3.0 | 3.0 | 3.5 | 6.0 | 8.0 | ◯ |
| c3 | 3.5 | 4.0 | 4.0 | 5.0 | 5.0 | ▴ |
| c4 | 3.0 | 3.0 | 3.0 | 3.0 | 3.0 | — |
| c5 | 3.5 | 3.5 | 3.5 | 5.0 | 5.0 | — |
| c6 | 5.0 | 5.0 | 5.0 | 5.0 | 5.0 | — |
| c7 | 3.5 | 4.0 | 4.0 | 8.0 | 8.0 | ◯ |
| c8 | 3.0 | 4.0 | 4.0 | 7.0 | 7.0 | ▴ |
| c9 | 3.0 | 3.0 | 3.0 | 4.0 | 4.0 | ▴ |
| c10 | 3.0 | 3.0 | 3.0 | 6.0 | 8.0 | — |
| Mean in | 3.4 | 3.6 | 3.7 | 4.6 | 4.8 | |
| group c | | | | | | |
| cc1 | 1.0 | 1.5 | 1.5 | 1.5 | 1.5 | ▴ |
| cc2 | 1.0 | 1.0 | 1.0 | 1.0 | 1.0 | — |
| cc3 | 2.0 | 2.0 | 2.0 | 3.5 | 3.5 | — |
| cc4 | 1.0 | 1.0 | 2.0 | 7.0 | 7.0 | ◯ |
| cc5 | 1.0 | 1.0 | 1.0 | 1.0 | 1.0 | — |
| cc6 | 2.0 | 2.0 | 2.0 | 3.0 | 3.0 | ▴ |
| cc7 | 2.0 | 2.0 | 2.0 | 3.0 | 3.0 | — |
| cc8 | 2.0 | 2.0 | 2.0 | 7.0 | 7.0 | ◯ |
| cc9 | 2.0 | 2.0 | 2.0 | 2.0 | 2.0 | — |
| cc10 | 2.0 | 3.0 | 3.0 | 6.0 | 6.0 | ◯ |
| Mean in | 1.6 | 1.8 | 1.9 | 2.3 | 2.3 | |
| group cc | | | | | | |
| Mean in | 2.5 | 2.7 | 2.8 | 3.5 | 3.5 | |
| the total | | | | | | |

TABLE 6
Example 2 (Ingredient: ground lotus root + lactic acid bacterium)

| | Frequency of defecation (time/week) | | | | | Constipation- |
|---|---|---|---|---|---|---|
| | Drug ingestion | | | | | relieving |
| Subject | Before | First | Second | Third | Fourth | effect on |
| No. | ingestion | week | week | week | week | fourth week |
| D1 | 3.0 | 6.0 | 6.0 | 6.0 | 6.0 | ◯ |
| D2 | 3.0 | 5.0 | 5.0 | 5.0 | 5.0 | ▴ |
| D3 | 3.0 | 3.0 | 3.0 | 3.0 | 3.0 | — |
| D4 | 2.5 | 6.0 | 6.0 | 7.0 | 7.0 | ◯ |
| D5 | 3.5 | 6.0 | 6.0 | 6.0 | 6.0 | ▴ |
| D6 | 3.5 | 6.0 | 7.0 | 7.0 | 7.0 | ◯ |
| D7 | 3.0 | 8.0 | 8.0 | 8.0 | 8.0 | ◯ |
| D8 | 2.5 | 4.0 | 4.0 | 4.0 | 4.0 | ▴ |
| D9 | 3.0 | 7.0 | 7.0 | 8.0 | 8.0 | ◯ |
| D10 | 3.0 | 6.0 | 6.0 | 8.0 | 8.0 | ◯ |
| Mean in | 3.0 | 5.7 | 5.8 | 6.2 | 6.2 | |
| group D | | | | | | |
| DD1 | 2.0 | 7.0 | 7.0 | 7.0 | 7.0 | ◯ |
| DD2 | 2.0 | 7.0 | 7.0 | 7.0 | 7.0 | ◯ |
| DD3 | 2.0 | 2.0 | 2.0 | 2.0 | 2.0 | — |
| DD4 | 2.0 | 4.0 | 7.0 | 7.0 | 7.0 | ◯ |
| DD5 | 2.0 | 3.0 | 3.0 | 3.0 | 3.0 | ▴ |
| DD6 | 2.0 | 6.0 | 7.0 | 7.0 | 7.0 | ◯ |
| DD7 | 2.0 | 7.0 | 7.0 | 7.0 | 7.0 | ◯ |
| DD8 | 1.0 | 1.0 | 1.5 | 1.5 | 1.5 | ▴ |
| DD9 | 1.0 | 7.0 | 7.0 | 7.0 | 7.0 | ◯ |
| DD10 | 1.0 | 1.5 | 1.5 | 1.5 | 1.5 | ▴ |
| Mean in | 1.7 | 4.6 | 5.0 | 5.0 | 5.0 | |
| group DD | | | | | | |
| Mean in | 2.4 | 5.2 | 5.4 | 5.6 | 5.6 | |
| the total | | | | | | |

As shown in Table 1, it was recognized that in Example 1 where the constipation-relieving drug containing both the lotus root extract and lactic acid bacteria was administered, 19 (95%) of 20 subjects had a constipation-relieving effect including significant and embodimentrate relief. As shown in Table 6, it was recognized that in Example 2 where the constipation-relieving drug containing both the ground lotus root and lactic acid bacteria was administered, 18 (90%) of 20 subjects had a constipation-relieving effect including significant and embodimentrate relief. In the subjects having the constipation-relieving effect, excrement was softened as compared with that before administration (provided that excrement did not become softener than normal).

As shown in Table 2, on the other hand, it was recognized that in Comparative Example 1 where only the lotus root extract in the same amount as in Example 1 was ingested, only 8 (40%) out of 20 subjects had a constipation-relieving effect including significant and embodimentrate relief. As shown in Table 4, it was recognized that in Comparative Example 3 where only lactic acid bacteria in the same amount as in Example 1 were ingested, only 8 (40%) out of 20 subjects had a constipation-relieving effect including significant and embodimentrate relief.

As shown in Table 3, it was recognized that in Comparative Example 2 where the lotus root extract in an amount as twice as that in Comparative Example 1 was ingested, only 10 (50%) out of 20 subjects had a constipation-relieving effect including significant and embodimentrate relief. As shown in Table 5, it was recognized that in Comparative Example 4 where lactic acid bacteria in an amount as twice as that in Comparative Example 3 were ingested, only 10 (50%) out of 20 subjects had a constipation-relieving effect including significant and embodimentrate relief.

The effect attained by ingesting either the lotus root extract or lactic acid bacteria, even in a doubled amount, was considerably inferior to the effect achieved by ingesting both the lotus root extract or ground lotus root and lactic acid bacteria. This result revealed that the drug containing the lotus root extract or ground lotus root and lactic acid bacteria, as compared with the drug containing only one of such ingredients, had a synergistic constipation-relieving effect over the mere additive effect.

Comparison between Example 1 and Example 2 revealed that Example 1 was superior in the effect to Example 2. The reason is not evident, but one possible reason is estimated as follows: The effect may be influenced by the process of preparing a ground lotus root used in Example 2; for example, there may be an influence of heating at 110° C. and/or hot-air drying.

In Examples 1 and 2 where the drug containing the lotus root extract or ground lotus root and lactic acid bacteria was ingested, a significant constipation-relieving effect was recognized on and after the first week of administration, as is evident from Table 1, Table 6 and FIG. 1. In Example 1, a further improvement in the constipation-relieving effect was recognized on the fourth week of ingestion. On the other hand, in Comparative Examples 1 to 4 where either the lotus root extract or lactic acid bacteria were ingested, the constipation-relieving effect was recognized on and after the third week of ingestion, as is evident from Tables 2 to 5 and FIG. 1.

These results revealed that the drug containing the lotus root extract or ground lotus root and lactic acid bacteria, as compared with the drug containing only one of such ingredients, had a synergistic constipation-relieving effect not only on the degree of the constipation-relieving effect but also on reduction of the period of ingestion before the effect is exhibited.

Table 7 shows how symptoms possessed by each subject before ingestion of the constipation-relieving drug were ameliorated 4 weeks after ingestion of the constipation-relieving drug in Example 1. The degree of relief is based on a subject's report. The ratio of the recognized significant and embodimentrate relief in each symptom is referred to as “Relief ratio” in Table 7.

TABLE 7

| | Degree of relief (number of subjects) | | | |
|---|---|---|---|---|
| | after 4 weeks of ingestion | | | Relief |
| | Significant | Embodimentrate | No | ratio |
| Diseases | relief | relief | change | (%) |
| Excessive | 1 | 5 | 3 | 67 |
| sensitivity to cold | | | | |
| Hemorrhoid | 2 | 2 | 0 | 100 |
| Ear ringing | 3 | 1 | 0 | 100 |
| Menopausal | 1 | 3 | 0 | 100 |
| syndrome | | | | |
| Hypertension | 0 | 3 | 1 | 75 |
| Menstrual | 1 | 1 | 1 | 67 |
| disorder | | | | |

As shown in Table 7, it was revealed that when the constipation-relieving drug in Example 1 was ingested for 4 weeks, excessive sensitivity to cold was relieved by 67%, hemorrhoid by 100%, ear ringing by 100%, menopausal syndrome by 100%, hypertension by 75% and menstrual disorder by 67%.

### INDUSTRIAL APPLICABILITY

The composition, drug, food additive and food of the present invention are used to relieve and treat constipation, excessive sensitivity to cold, hemorrhoid, ear ringing, menopausal syndrome, hypertension and menstrual disorder.

1-6. (canceled)

7. A composition comprising ground lotus and/or a lotus extract and a lactic acid bacterium, wherein the composition is a constipation-relieving drug, a constipation-relieving food additive, or a constipation-relieving food.
